(19) United States
(12) Patent Application Publication
(10) Pub. No.: US 2013/0162809 A1
(43) Pub. Date: Jun. 27, 2013

(54) LIGHT-HOMOGENIZING IMAGING DEVICE FOR A BEAD SORTING MACHINE

(71) Applicants: YA-CHEN HSU, Taichung City (TW); Fang-Chih Tien, Taichung City (TW)

(72) Inventors: YA-CHEN HSU, Taichung City (TW); Fang-Chih Tien, Taichung City (TW)

(21) Appl. No.: 13/338,196

(22) Filed: Dec. 27, 2011

(51) Int. Cl. H04N 7/18

(52) U.S. Cl. 348/91; 348/E07.085

(57) ABSTRACT

A light-homogenizing imaging device for a bead sorting machine comprises: a light permeable ball carrier, two light sources, and an image pick-up device. The light permeable ball carrier is formed with a hole for holding a ball to be checked, a depth of the hole is larger than a diameter of the ball, and a cross sectional area of the hole is larger than or equal to a cross sectional area of the ball. The two light sources are disposed at both sides of the light permeable ball carrier and located in the direction of the hole. The image pick-up device is located toward the hole of the light permeable ball carrier. The light permeability of the light permeable carrier enables the light to be evenly dispersed over the surface of the ball without producing shadows that has influence on the ball checking, thus improving the checking accuracy.

### BACKGROUND OF THE INVENTION

1. Field of the Invention

The present invention relates to a device for sorting and checking balls, and more particularly to a light-homogenizing imaging device for a bead sorting machine.

2. Description of the Prior Art

The method for checking and sorting balls by using a conventional ball checking device is such that the light is directly projected onto the balls, and the reflected light from the balls is compared to a reference value to determine whether the balls being checked are good or not. However, when the light is not evenly dispersed over the balls, shadows will be produced, which will affect the accuracy of checking the balls.

### SUMMARY OF THE INVENTION

The primary object of the present invention is to provide a light-homogenizing imaging device for a bead sorting machine, which can improve the checking accuracy by evenly dispersing the light of the light sources over the surface of the ball to be checked.

To achieve the above object, a light-homogenizing imaging device for a bead sorting machine in accordance with the present invention comprises: a light permeable ball carrier, two light sources, and an image pick-up device. The light permeable ball carrier is formed with a hole for holding a ball to be checked, a depth of the hole is larger than a diameter of the ball, and a cross sectional area of the hole is larger than or equal to a cross sectional area of the ball. The two light sources are disposed at both sides of the light permeable ball carrier and located in the direction of the hole. The image pick-up device is located toward the hole of the light permeable ball carrier.

### BRIEF DESCRIPTION OF THE DRAWINGS

FIG. 1 is a perspective view of a light-homogenizing imaging device for a bead sorting machine in accordance with the present invention;

FIG. 2 is a cross sectional view of the light-homogenizing imaging device for a bead sorting machine in accordance with the present invention; and

FIG. 3 is an operational view of the light-homogenizing imaging device for a bead sorting machine in accordance with the present invention, showing that a ball is being hold in the light permeable ball carrying device.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

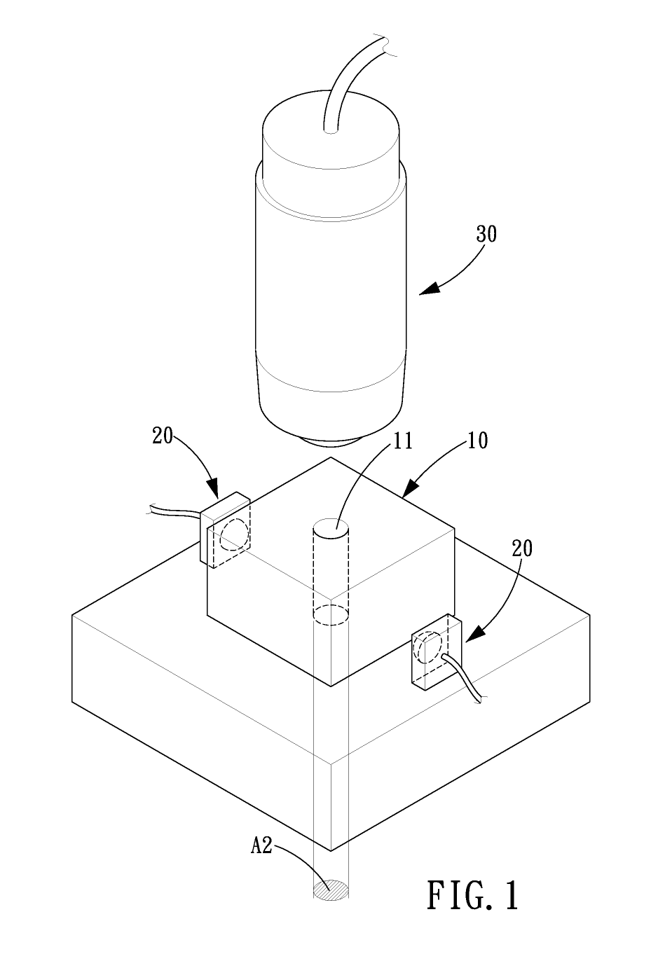

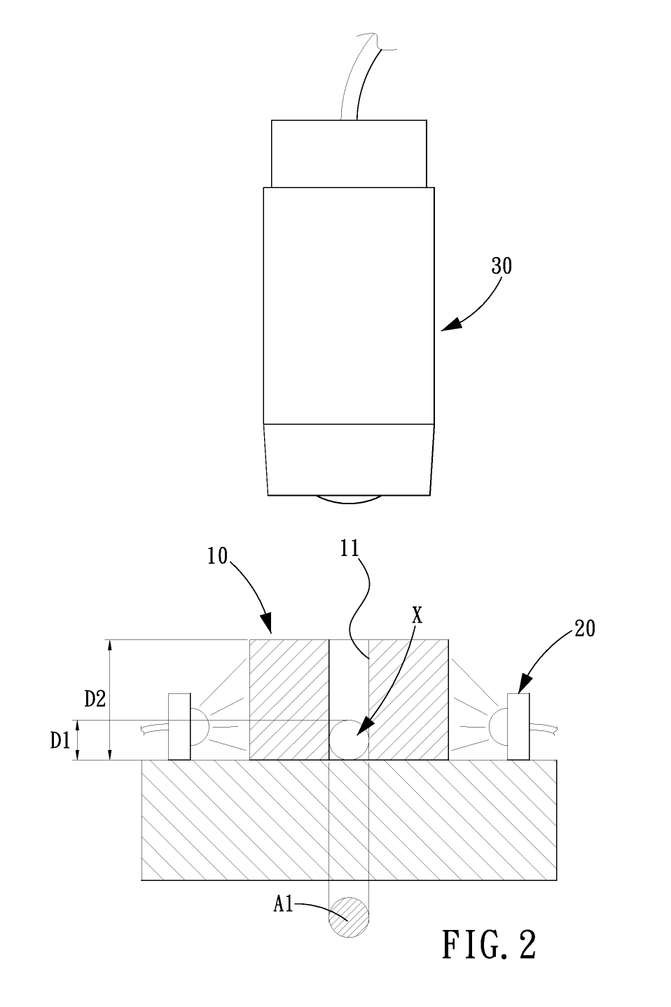

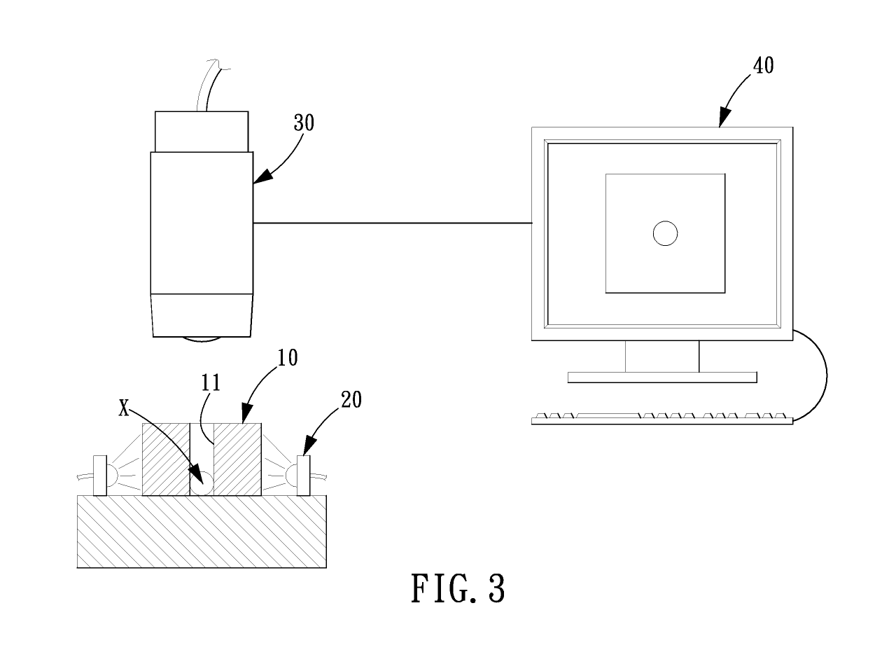

Referring to FIGS. 1-3, a light-homogenizing imaging device for a bead sorting machine in accordance with the present invention comprises a light permeable ball carrier 10, two light sources 20, an image pick-up device 30 and a display 40.

The light permeable ball carrier 10 is formed with a hole 11 for holding a ball X to be checked. A depth D2 of the hole 11 is 1.5-2 times a diameter D1 of the ball X, and a cross sectional area A2 of the hole 11 is larger than or equal to a cross sectional area A1 of the ball X, so that the ball X can be received in the hole 11 of the light permeable ball carrier 10.

The two light sources 20 are disposed at both sides of the light permeable ball carrier 10 and located in the direction of the hole 11.

The image pick-up device 30 is located toward the hole 11 of the light permeable ball carrier 10.

The display 40 is electrically connected to the image pick-up device 30 to display the images picked up by the image pick-up device 30.

When in use, the ball X to be checked is received in the hole 11 of the light permeable ball carrier 10, the two light sources 20 project light onto the light permeable ball carrier 10, and then the light can be uniformly distributed over the surface of the ball X in the hole 11 by the light permeable ball carrier 10. Since the depth D2 of the hole 11 of the light permeable ball carrier 10 is 1.5-2 times the diameter D1 of the ball X, the ball X can be fully received in the hole 11. Hence, when the two light sources 20 project light onto the light permeable ball carrier 10, the light permeable property of the light permeable carrier 10 enables the light to be evenly and uniformly dispersed over the surface of the ball X without producing shadows that has influence on the ball checking, and thus improving the checking accuracy.

Therefore, the image pick-up device 30 above the light permeable ball carrier 10 can pick up the image of the ball X that is evenly illuminated by the light from the light sources 20, and the image error of the ball X caused by lack of light or shadows can be prevented. Finally, the image picked up by the image pick-up device 30 is displayed on the display 40, so that the user can see the image of the ball X clearly on the display 40 clearly to find out whether the ball X is good or not.

While we have shown and described various embodiments in accordance with the present invention, it is clear to those skilled in the art that further embodiments may be made without departing from the scope of the present invention.

What is claimed is:

1. A light-homogenizing imaging device for a bead sorting machine comprising: a light permeable ball carrier, two light sources, and an image pick-up device;
the light permeable ball carrier being formed with a hole for holding a ball to be checked, a depth of the hole being larger than a diameter of the ball, and a cross sectional area of the hole being larger than or equal to a cross sectional area of the ball;
the two light sources being disposed at both sides of the light permeable ball carrier and located in the direction of the hole; and
the image pick-up device being located toward the hole of the light permeable ball carrier.

2. The light-homogenizing imaging device for a bead sorting machine as claimed in claim 1, wherein the depth of the hole is 1.5-2 times the diameter of the ball.

3. The light-homogenizing imaging device for a bead sorting machine as claimed in claim 1 further comprises a display electrically connected to the image pick-up device to display the images picked up by the image pick-up device.
